(19) United States
(12) Patent Application Publication
(10) Pub. No.: US 2014/0174955 A1
(43) Pub. Date: Jun. 26, 2014

(54) HIGH FLOW XEF2 CANISTER

(71) Applicant: QUALCOMM MEMS TECHNOLOGIES, INC., San Diego, CA (US)

(72) Inventor: Teruo Sasagawa, Los Gatos, CA (US)

(73) Assignee: QUALCOMM MEMS Technologies, Inc., San Diego, CA (US)

(21) Appl. No.: 13/725,913

(22) Filed: Dec. 21, 2012

(51) Int. Cl. F17C 1/00; B65B 5/02

(52) U.S. Cl. CPC F17C 1/00; B65B 5/02
USPC 206/6; 53/467

(57) ABSTRACT

This disclosure provides systems, methods and apparatus for delivery of gas from solid phase sources. A solid phase gas source canister can include multiple separated volumes configured to contain multiple quantities of a solid phase gas source. Sublimated vapor can be independently produced by each quantity of the solid phase gas source. In some implementations, the solid phase gas source canisters are configured for simultaneous fill of the multiple volumes with a solid source gas phase powder.

### TECHNICAL FIELD

This disclosure relates generally to gas delivery from solid phase sources in processing systems.

### DESCRIPTION OF THE RELATED TECHNOLOGY

Solid phase gas sources may be used in various manufacturing processes. For example, solid xenon difluoride (XeF₂) may be used in etching processes to manufacture electromechanical systems (EMS) devices. EMS devices include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers.

Electromechanical elements may be created using deposition, etching, lithography, and/or other micromachining processes that etch away parts of substrates and/or deposited material layers, or that add layers to form electrical and electromechanical devices. Solid phase gas sources may also be used in the manufacture of other types of devices, including integrated circuit (IC) devices. For example, vapors derived from solid XeF₂ may be used to remove sacrificial layers. In another example, solid phase gas sources may provide vapor reactants in atomic layer deposition (ALD) and chemical vapor deposition (CVD) processes.

### SUMMARY

The systems, methods and devices of the disclosure each have several innovative aspects, no single one of which is solely responsible for the desirable attributes disclosed herein.

One innovative aspect of the subject matter described in this disclosure can be implemented in a solid phase source gas delivery system. The solid phase source gas delivery system can include a cylindrical inner container including multiple separated volumes configured to contain separated quantities of a solid phase gas source. The volumes can be separated by shelves configured to support the quantities of the solid phase gas source. The solid phase source gas delivery system can further include a central tube extending through the inner container in fluid communication with the separated volumes and a side cover movable to access the separated volumes. In some implementations, the side cover is movable to access the separated volumes simultaneously. Also in some implementations, the side cover can have a surface area of less than half the lateral surface area of the inner container. In some implementations, the canister is configured such that sublimated vapor exits the canister through the central tube. In some implementations, the canister is configured for carrier gas injection through the central tube. The solid phase source gas delivery system can include an outlet channel offset from the central tube. The outlet channel diameter can be greater than the central tube diameter.

The solid phase source gas delivery system can include an outer container configured to contain the inner container. In some implementations, a gas passageway in fluid communication with the separated volumes is disposed between the inner container and the outer container. The solid phase source gas delivery system can include rods extending from each shelf into each separated volume. The rods can facilitate heat transfer to the solid phase gas source.

In some implementations, the solid phase source gas delivery system can produce vapor, for example xenon difluoride (XeF₂) vapor at a capacity of at least about 10 sccm per shelf. The solid phase source gas delivery system can be configured to deliver sublimated vapor to a substrate processing chamber in some implementations.

Another innovative aspect of the subject matter described in this disclosure can be implemented in a solid phase source gas delivery system including containing means for containing a plurality of separated quantities of a solid phase gas source and means for simultaneously introducing the separated quantities of the solid phase gas source to the delivery system. In some implementations, the solid phase source gas delivery system can further include comprising means for providing a stream of sublimated vapor from the plurality of separated quantities of the solid phase gas source. In some implementations, the solid phase source gas delivery system includes means for providing a carrier gas to the containing means. Also in some implementations, the solid phase source gas delivery system includes means for means for preventing spillage while introducing the separated quantities to the delivery system.

Another innovative aspect of the subject matter described in this disclosure can be implemented in a method of filling a solid phase source canister. The method can include providing an inner container including multiple volumes separated by shelves, blocking open holes of the inner container, opening a side of the inner container, partially filling the separated volumes with a solid phase gas source, replacing the side cover, positioning the inner container upright, and opening the blocked holes of the inner container. The separated volumes can be partially filled simultaneously. In some implementations, blocking open holes of the inner container includes inserting a pole into a central tube.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a flow diagram illustrating a manufacturing process for an interferometric modulator IMOD display or display element.

FIGS. 2A-2E are cross-sectional illustrations of various stages in a process of making an IMOD display or display element.

FIG. 3 shows an example of a schematic illustration of a solid phase gas delivery source.

FIGS. 4A and 4B show examples of schematic illustrations of a solid phase gas source canister.

FIGS. 5A and 5B show examples of schematic illustrations of isometric and top views of a shelf of a solid phase gas source canister.

FIG. 6 shows an example of a schematic illustration of a solid phase gas source canister configured for carrier gas injection.

FIGS. 7A and 7B show examples of cross-sectional views of a solid phase gas canister.

FIG. 8 is an example of a flow diagram illustrating a process for filling a solid phase gas source canister.

FIGS. 9A-9J and 10A-10D show examples of cross-sectional illustrations of various stages in processes of filling a solid phase gas source canister.

FIG. 11 shows an example of a schematic illustration of design dimensions of a shelf of a solid phase source gas canister.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, method, or system that uses solid phase gas sources or is made by a manufacturing process that uses solid phase gas sources. More particularly, it is contemplated that the described implementations may be included or associated with methods, apparatus, or systems for a wide variety of processes that employ sublimated vapor such as, but not limited to, chemical vapor deposition (CVD) process, atomic layer deposition (ALD) processes, and etching processes.

It is also contemplated that the described implementations may be included in or associated with manufacturing processes and systems for electromechanical systems (EMS) and electronic devices. The described implementations may be included in or associated with different chemical processing tools, including but not limited to single chamber processing apparatuses, multi-chamber processing apparatuses, multi-chamber cluster tools, multi-substrate chamber processing apparatuses, etc.

Some implementations relate to solid phase gas source canisters that produce high gas flow rates. The canisters can facilitate sublimation by providing increased surface area of the solid phase source powder available for sublimation. In some implementations, the canisters include multiple shelves, each of which can support a quantity of a solid phase gas source. Sublimated vapor can be produced independently by each quantity, with the flow rate of the sublimated vapor increasing linearly with the number of shelves in the canister. In some implementations, a canister can be configured for carrier gas injection.

Some implementations relate to easy to load solid phase gas source canisters. The canisters can be configured such that multiple separated volumes can be filled simultaneously in one filling operation. In some implementations, the canisters include a movable side door. The side door can provide simultaneous access to the multiple individual volumes. In some implementations, the side door is sized to provide a fill line.

Particular implementations of the subject matter described in this disclosure can be implemented to realize one or more of the following potential advantages. The high flow rate canisters can shorten process times and increase throughput. The canisters can be quickly and easily loaded, reducing labor and costs. In some implementations, the canister allows an increase in the area provided for sublimation of a solid phase gas source without increasing the diameter of the canister. In some implementations, the canister design is flexible and can allow an increase in flow rate by increasing the number of the shelves and/or increasing the diameter of the canister. The flexible canister design can provide a multifold increase in flow rate that scales with the number of shelves with an increase in canister diameter.

Many manufacturing processes for EMS, semiconductor, and other electronic devices employ vapor phase reactions while many chemical reactants and precursors are in solid phase at standard temperature and pressure. Accordingly, vapors derived from solid phase sources may be used in a variety of chemical processes, including, but not limited to, deposition and etching processes.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

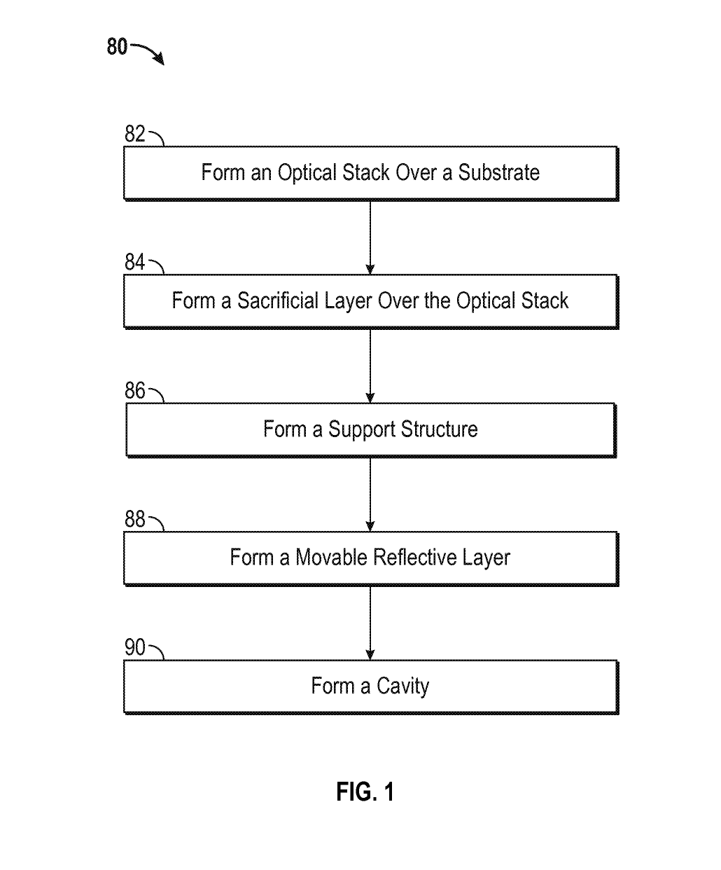

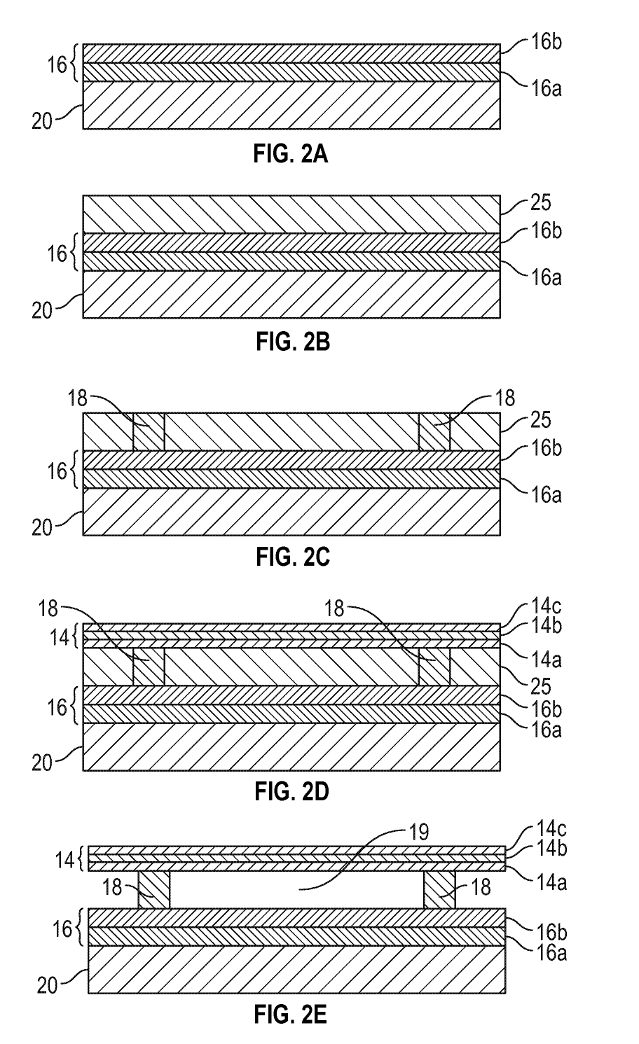

An example of a process of manufacturing an IMOD that can employ sublimated vapor is described below with respect to FIGS. 1 and 2A-2E. FIG. 1 is a flow diagram illustrating a manufacturing process 80 for an IMOD display or display element. FIGS. 2A-2E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 1. The process 80 begins at block 82 with the formation of the optical stack 16 over the substrate 20. FIG. 2A illustrates such an optical stack 16 formed over the substrate 20. The substrate 20 may be a transparent substrate such as glass or plastic. The substrate 20 may be flexible or relatively stiff and unbending, and may have been subjected to prior preparation processes, such as cleaning, to facilitate efficient formation of the optical stack 16. The optical stack 16 can be electrically conductive, partially transparent, partially reflective, and partially absorptive, and may be fabricated, for example, by depositing one or more layers having the desired properties onto the transparent substrate 20.

In FIG. 2A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 2A-2E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 2B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 2E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 2C, the aperture formed in the sacrificial layer 25 can extend through the sacrificial layer 25, but not through the optical stack 16. For example, FIG. 2E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 2C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 2E. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 2D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

Manufacturing of IMODs and other EMS or electronic devices may employ processing of a large number of devices on large format substrates. For example, a substrate such as the substrate 20 in FIGS. 2A-2E can be a panel on which tens to hundreds of thousands or more devices are fabricated. In some implementations, such a substrate can be sized such that a diameter or length and width dimensions, also referred to as the lateral dimensions, are each greater than 200 mm. In some implementations, the lateral dimensions of a substrate can be at least 600 mm×800 mm. In some implementations, a diameter or one or both of the width and length can be 1 meter or greater. In some implementations, multiple substrate processes for EMS and other electronic device manufacturing may be performed, with a processing chamber configured to process multiple substrates simultaneously. In some implementations, solid phase gas delivery sources provide sublimated vapor for processes, including large area and/or multiple substrate processes, that use high flow rates of the sublimated vapor.

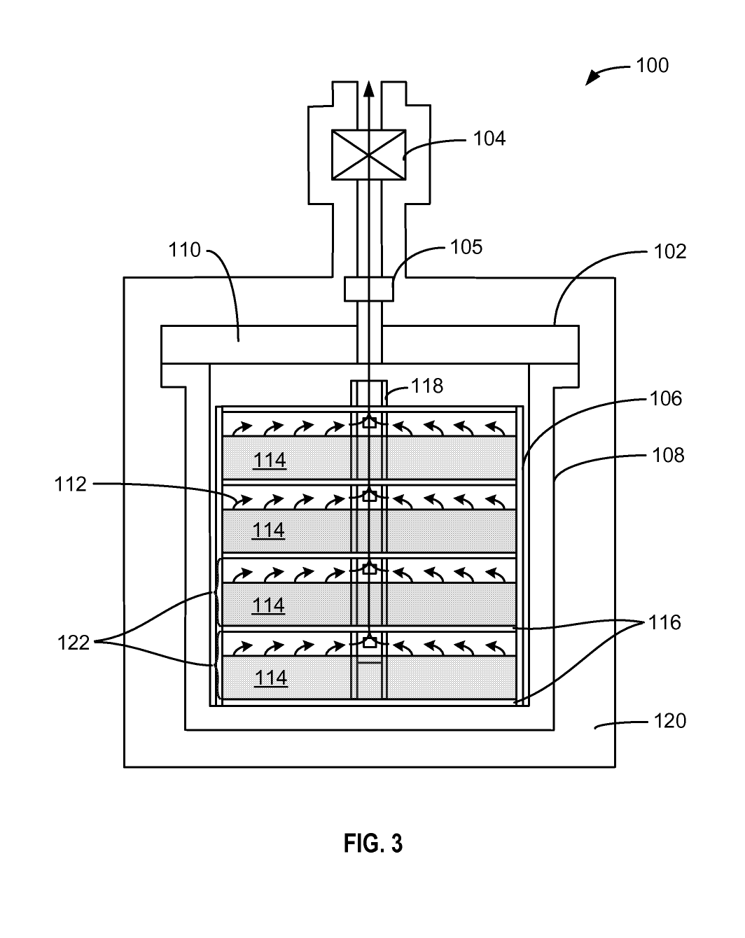

FIG. 3 shows an example of a schematic illustration of a solid phase gas delivery source. The solid phase gas delivery source 100 includes a canister 102 that can be connected to a reaction chamber or buffer tank (not shown) through a port 105 and a valve 104. The canister 102 includes an inner container 106, an outer container 108, and a flange 110 that covers the inner and outer containers 106 and 108. The inner container 106 includes multiple shelves 116 and a central tube 118 that can act as a gas passageway. The shelves 116 create multiple separated volumes 122 within the canister 102. A solid phase gas source 114 fills a portion of the volume 122 above each shelf 116. In some implementations, between about 50% and 90% of each separated volume 122 is designed to be filled with the solid phase gas source 114 prior to sublimation and delivery to the reaction chamber. For example, if the height of the volume 122 above each shelf 116 is about 12 cm, the fill line prior to sublimation may be between about 6 cm and 11 cm. As the solid phase gas source 114 sublimates and leaves the canister 102, the portion of the separated volumes 122 occupied by the solid phase gas source 114 decreases.

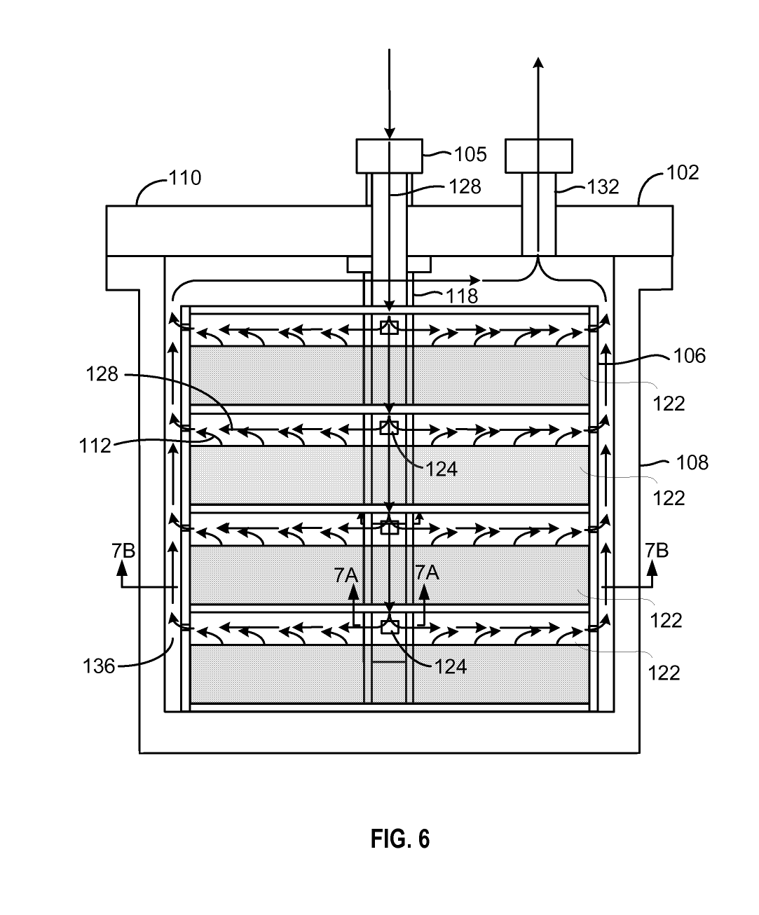

The solid phase gas source 114 can be, for example, in powder or other fillable form. A heating jacket 120 can surround the canister 102, providing energy for sublimation of solid phase gas source 114 contained in the canister 102 and preventing condensation. In some implementations, a heating jacket is not employed with the sublimation occurring at the temperature of the surrounding atmosphere. Sublimated vapor 112 is produced from the sublimation of the solid phase gas source 112 in the unfilled portion of the volume 122 above each shelf 116 and combines to form a stream of vapor to be delivered to the reaction chamber, buffer tank, or other desired destination. In the example of FIG. 3, the sublimated vapor 112 exits the canister 102 via the central tube 118, though other gas flow path configurations may be used. For example, as discussed below with respect to FIG. 6, in some implementations, the sublimated vapor 112 can exit the canister 102 via a flow path between the inner and outer containers 106 and 108.

The available surface area of the solid phase gas source 112 increases linearly with the number of separated volumes 122. Because sublimation rate correlates linearly with available surface area of the solid phase gas source 114, a multi-shelf canister such as illustrated in FIG. 3 produces sublimated vapor than a canister containing a single volume of solid phase gas source. For example, a canister with four shelves produces sublimated vapor at a rate four times that of a shelf-less canister filled with a single volume of powder. The gas canisters described herein can produce sublimated vapors of flow rates of 10 sccm per shelf, for total flow rates of least about 20 sccm, for example 50 sccm. Capacity can be arbitrarily large by scaling up the number of shelves.

In some implementations, the solid phase gas source 112 is a low volatility compound and has a vapor pressure below about 100 Torr at room temperature. One example of a low volatility solid phase gas source is XeF₂, which has a vapor pressure of about 3.8 Torr at 25° C. Sublimated XeF₂ vapor can be used, for example, as in block 90 of process 80 in FIG. 1. Other examples include xenon tetrafluoride (XeF₄), xenon hexafluoride (XeF₆), hafnium chloride (HFCl₄), zirconium chloride (ZrCl₄), indium trichloride (InCl₃), indium chloride (InCl), aluminum chloride (AlCl₃), 2,2,6,6-tetramethyl-3,5-heptadionate (DPM)-containing compounds such as strontium (DPM)₂(Sr(DPM)₂), titanium oxide (DPM)₂(TiO(DMP)₂), Zr(DPM)₄), tetrakis(dimethylamino)titanium (TDMAT), pentakis(dimethylamino)tantalum (PDMAT), tris(diethylamino)(tert-butylimido)tantalum (TBTDET), tetrakis(dimethylamido)zirconium(IV) (Zr(NMe₂)₄), hafnium tertiarybutoxide (Hf(tOBu)₄), and titanium iodide (TiI).

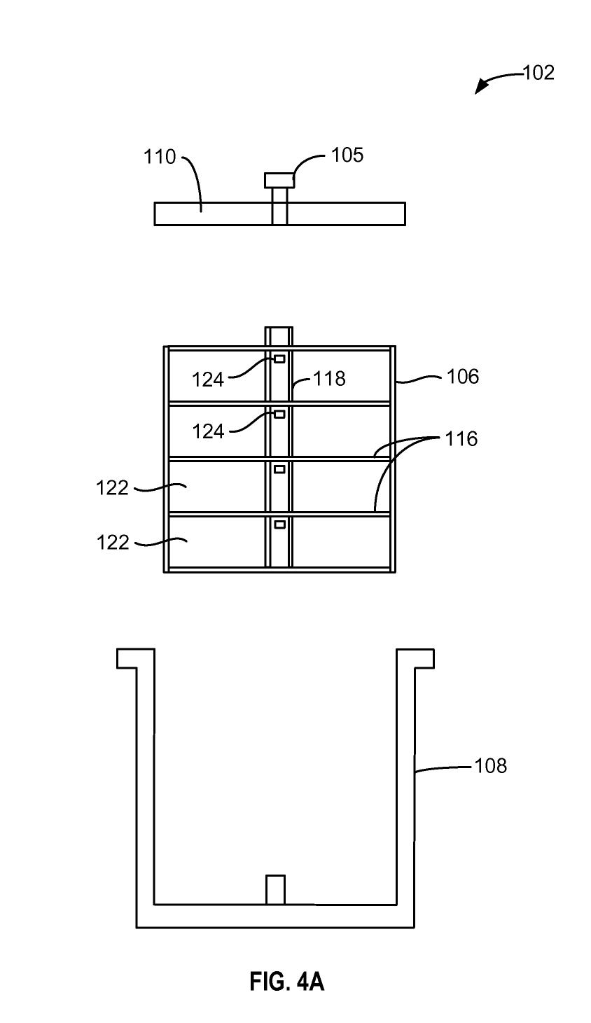

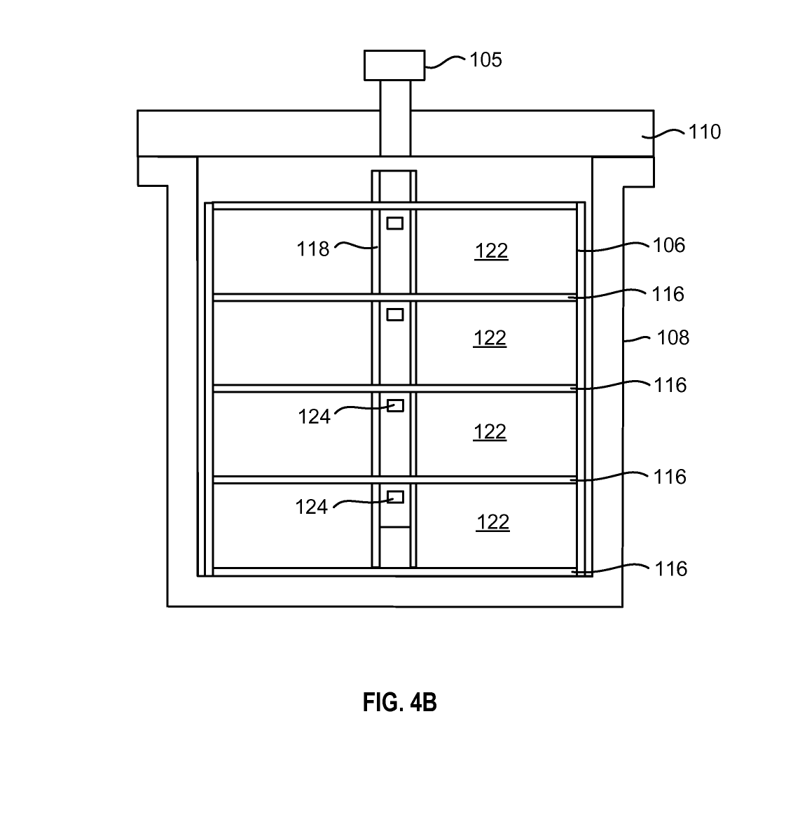

FIGS. 4A and 4B show examples of schematic illustrations of a solid phase gas source canister. FIG. 4A shows the canister in an unassembled state and FIG. 4B in an assembled state. As noted above, the canister 102 can include an inner container 106, an outer container 108 and a flange 110. The inner container 106 can include two or more shelves 116, with an arbitrary number of shelves possible. The number of shelves can be determined in part by the desired flow rate of the sublimated vapor stream. A central tube 118 includes holes 124 associated with separate volumes 122 to allow gas flow between the central tube 118 and separated volumes 122. The inner container 106 fits within the outer container 108, as shown in the example of FIG. 4B, with flange 110 covering the inner container 106 and outer container 108. The flange 110 can seal the canister 102, preventing gas flow between the atmosphere and the canister 102 except through a port 105 or other desired gas passageway (not shown). The shelves may or may not be removable from the inner container 106. In some implementations, the shelves 116 are not separable from one another and/or the central tube 118. The holes 124 can be located at or near the tops of the separated volumes 122 to provide accessible volume for solid phase gas source fill that does not reach the holes 124.

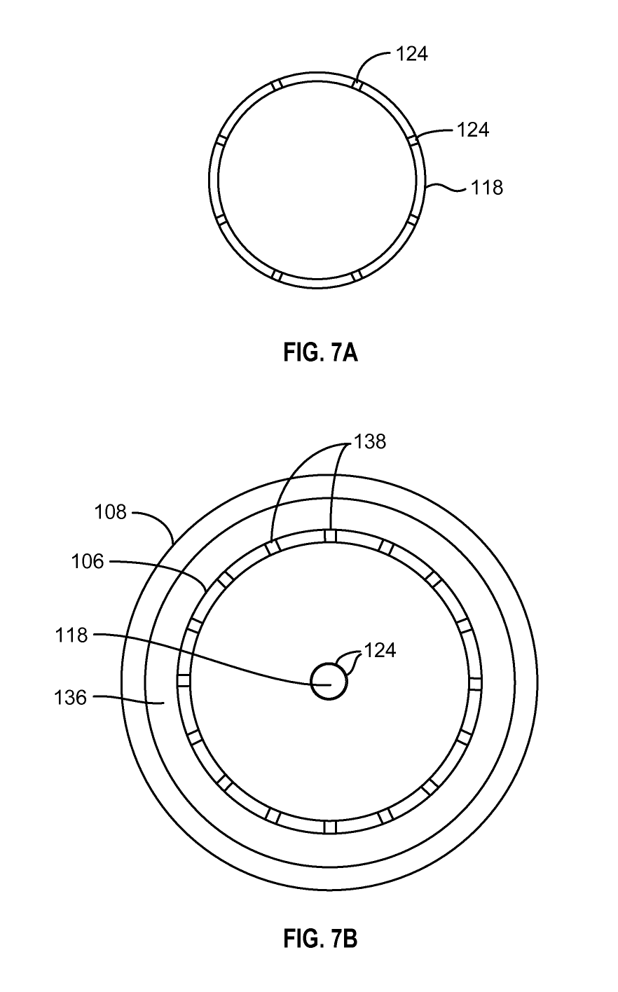

The canister material can be any material with good thermal conductivity that is inert to the solid phase gas source and sublimated vapor. Examples include aluminum (Al), copper (Cu), silver (Ag), and alloys thereof. The inner surface of the canister should be inert to the solid phase gas source. In some implementations, the material can be coated with the chemical resistant material. Examples of coatings include Teflon™ and other inert fluoropolymers, stainless steel such as SS317 or SS314, anodized Al, aluminum oxide (Al₂O₃) spray, and yttrium oxide (Y₂O₃) spray. The canister can be any appropriate size, and can be for example, sized to fit into a standard gas cabinet. Example dimensions of the canister are discussed further below with reference to FIGS. 7A and 7B. In some implementations, the canister can be cylindrical, with the shelves circular, to allow even sublimation rates across each shelf

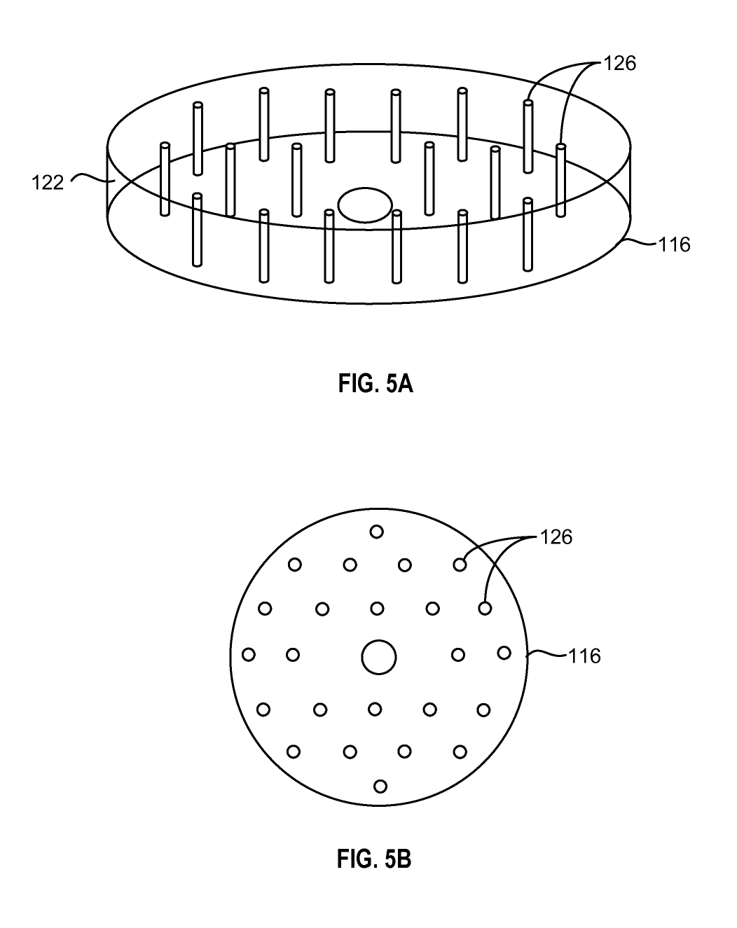

The temperature at which sublimation occurs can depend on the particular solid phase gas source used. For XeF₂, for example, the canister can be heated to between about 30° C. and 60° C., such as 42° C. In some implementations, the shelves of a multi-shelf canister can include rods or other features to facilitate heat transfer to the solid phase gas source. FIGS. 5A and 5B show examples of schematic illustrations of isometric and top views of a shelf of solid phase gas source canister. Rods 126 extend from a shelf 116 into a separated volume 122 above the shelf 116. In some implementations, the rods 126 can extend partway into the separated volume 122 such that, when the separated volume is partially filled with powder, the rods 126 extend through all or most of the thickness of the powder. The rods 126 can be any material with good thermal conductivity that is inert to the solid phase gas source and sublimated vapor. As with the shelf 116, in some implementations, the rods 126 can have a high thermal conductivity core material and be coated with a chemically inert compound. For example, the rods 126 can include SS316-coated Cu, Ag, or Al. Other possible coatings include Teflon™, anodized Al, Al₂O₃, Y₂O₃, and other coatings inert to the solid phase gas source. The rods 126 can be made of the same or different material as the shelf 116. The rods 126 can be arranged to provide uniform heat transfer to the solid phase gas source across the shelf 116. In one example, the rods 126 can be uniformly arranged across the shelf 116. In another example, the rods 126 can be arranged such they are less dense closer to a heating jacket or other heat source.

In some implementations, the gas canister can be configured for carrier gas injection. A carrier gas may be used to sweep the sublimated vapor into an outlet channel for delivery to reaction chamber, buffer tank, or other desired destination. FIG. 6 shows an example of a schematic illustration of a solid phase gas source canister configured for carrier gas injection. The solid phase gas source canister 102 includes an inner container 106 including a central tube 118, an outer container 108, and a flange 110. A carrier gas 128 can be injected through a port 105 into the central tube 118, and exit through holes 124 in the central tube 118 into multiple separated volumes 122. The carrier gas mixes with the sublimated vapor 112, sweeping it out to an outer channel 136 defined by and between the inner container 106 and the outer container 108. A gas mixture of the sublimated vapor and the carrier gas flows out of an outlet channel 132 to a reaction chamber, buffer tank, or other desired destination. Outlet channel 132 typically has larger diameter than the central tube 118. Cross-sectional views of the central tube 118 and the canister 102 are shown in FIGS. 7A and 7B, as indicated, and described below.

FIGS. 7A and 7B show examples of cross-sectional views of a solid phase gas canister. First, turning to FIG. 7A, the central tube 118 includes holes 124 to permit gas flow between the central tube 118 and the separated volumes of the canister. The diameter of the central tube 118 and the size and number of the holes 124 can vary according to the capacity of the canister. As examples, the holes 124 can have diameters between about 0.5 mm and 1 mm, with 8-16 holes per shelf or separated volume. The tube diameter can range between about 1 cm and 5 cm. Example thicknesses of the tube wall can range between about 2 mm and 10 mm. According to various implementations, the dimensions and/or number of holes may be outside these ranges.

Turning to FIG. 7B, the outer container 108 and the inner container 106 define an outer channel 136. The inner container 106 includes holes 138 to permit gas flow between the separated volumes of the inner container 106 and the outer channel 136. In some implementations, the inner container 106 does not include the holes 138, such as depicted in FIG. 3. Example thicknesses of the outer container 108 can range from 0.5 cm to 5 cm. Example thicknesses of the inner container 106 can range from 1 mm to 20 mm. Example widths of the outer channel 136 can range from 0.5 cm to 3 cm. Example inner diameters of the outer container 108 can range from 15 cm to 30 cm. Example inner diameters of the inner container 106 can range from 10 cm to 25 cm. Example diameters of the holes 138 can between about 1 mm and 10 mm, with 8-24 holes per shelf or separated volume. According to various implementations, the dimensions and/or number of holes may be outside these ranges. Like the holes 124, the holes 138 can be located such that they are at or near the tops of the separated volumes 122 to provide accessible volume for a solid phase gas source.

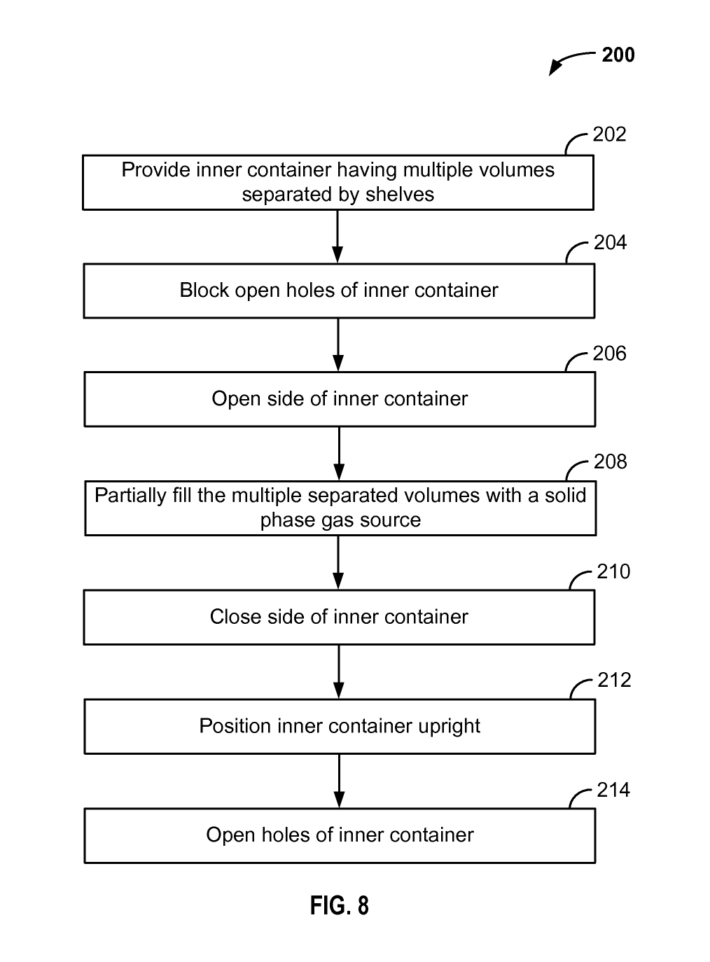

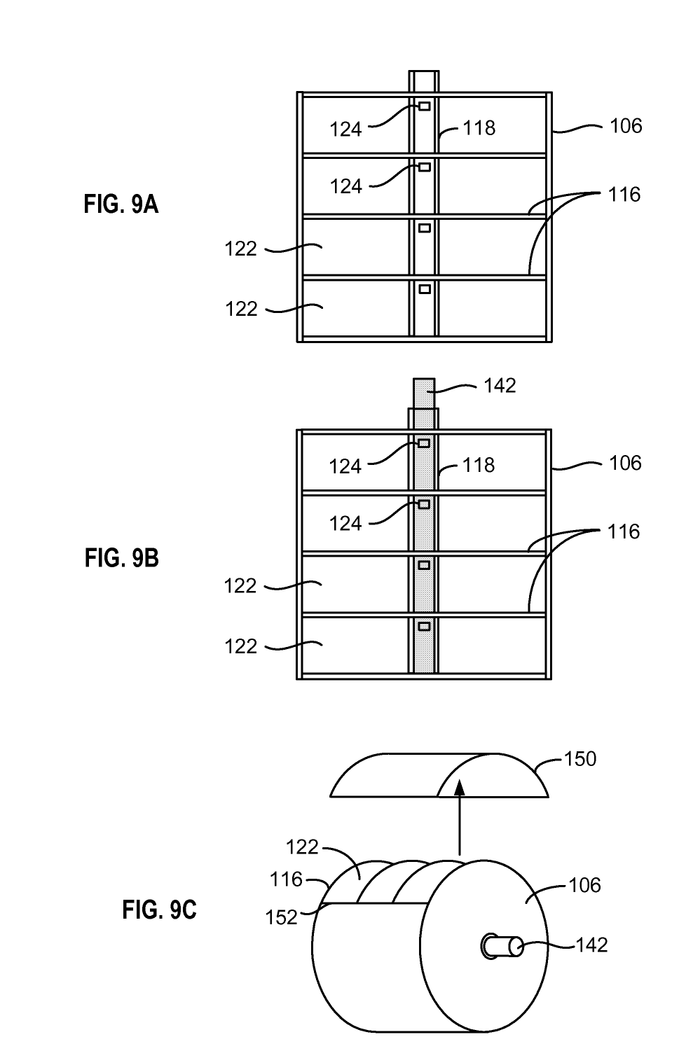

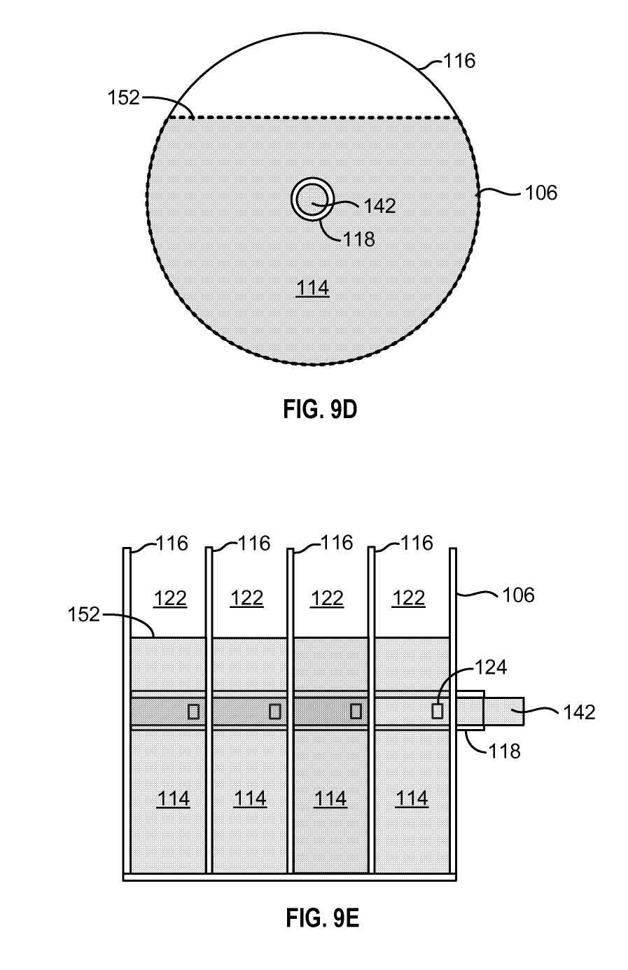

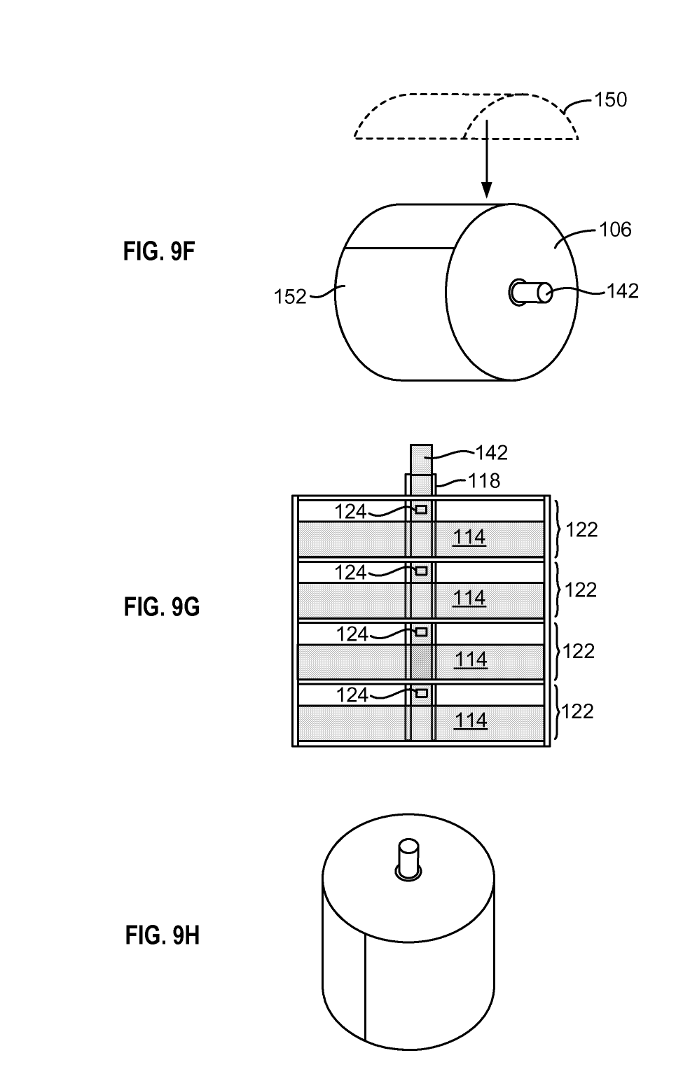

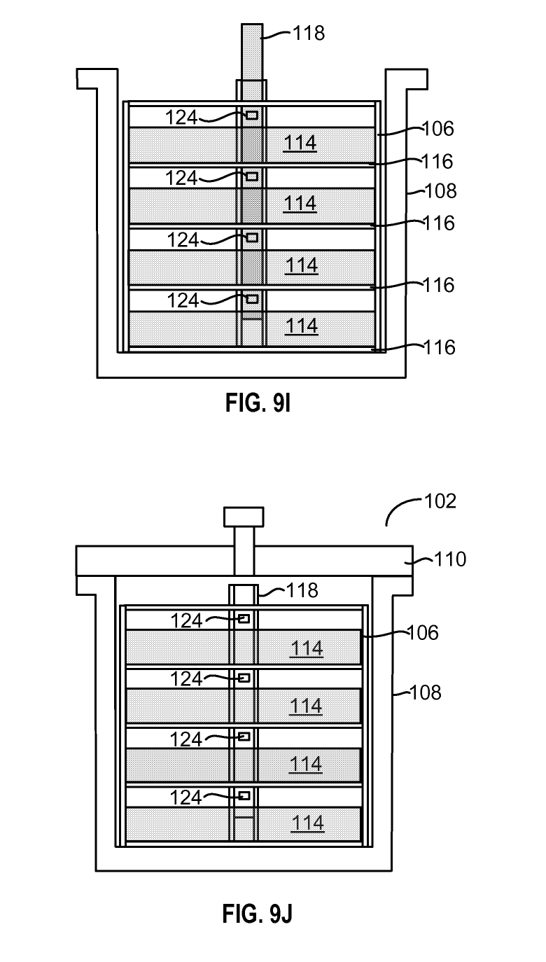

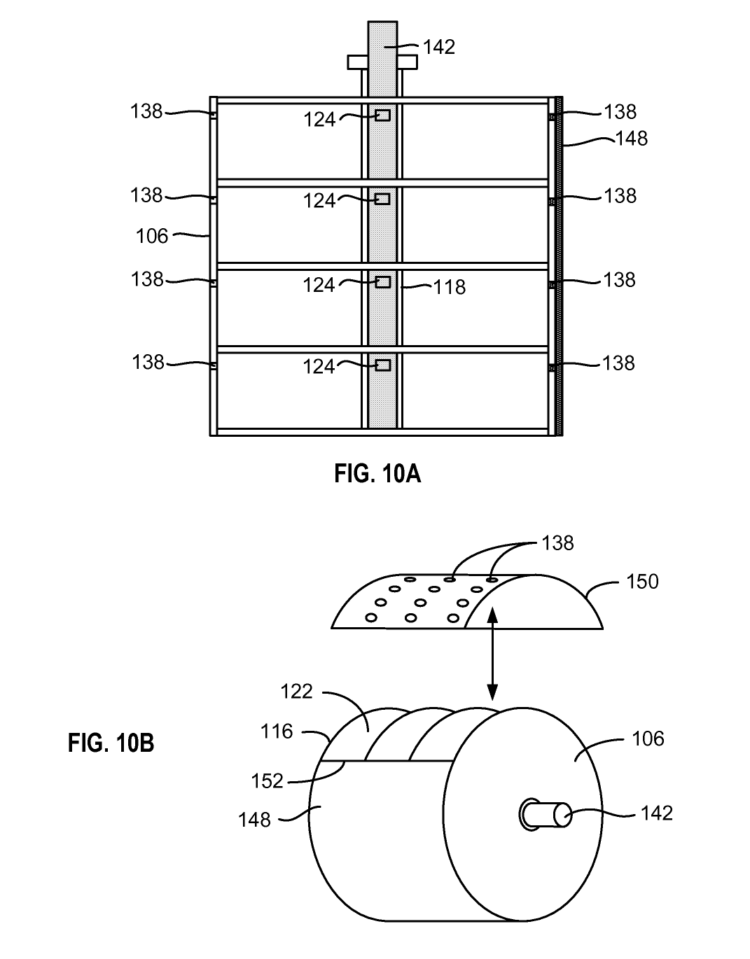

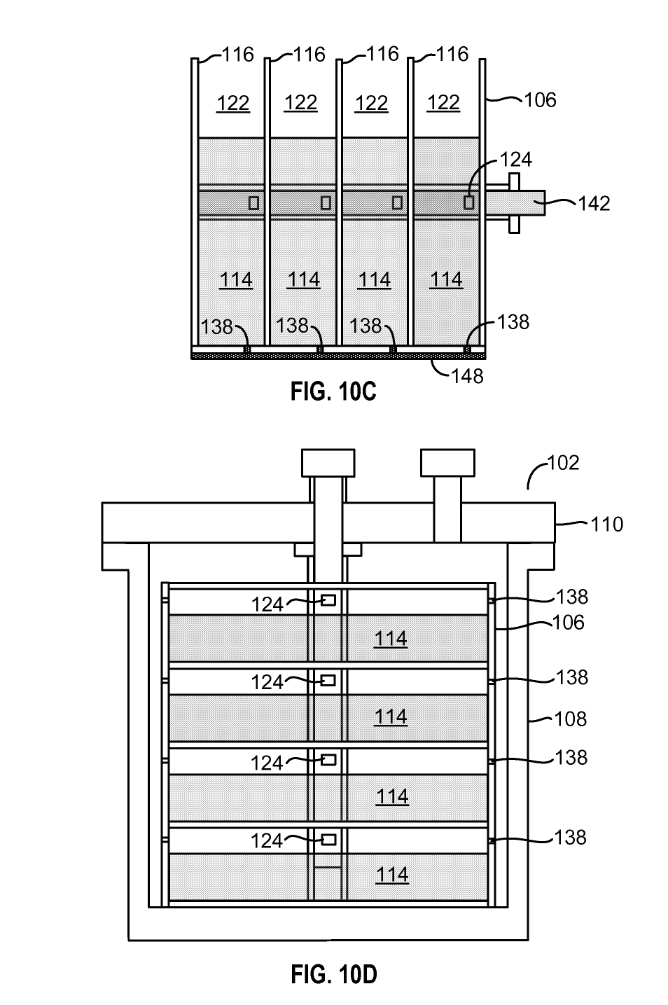

In some implementations, the canisters described herein are configured for quick and easy fill. FIG. 8 is an example of a flow diagram illustrating a process for filling a solid phase gas source canister. FIGS. 9A-9J and 10A-10D show examples of cross-sectional illustrations of various stages in processes of filling a solid phase gas source canister. The process 200 begins at block 202 with providing an inner container including multiple volumes separated by shelves. FIG. 9A shows an example of an inner container 106 including multiple separated volumes 122 separated by shelves 116. As illustrated, the volumes 122 are empty prior to fill. In the example of FIG. 9A, the inner container 102 also includes a central tube 118 with holes 124 to permit gas flow as described above with respect to FIG. 4A. The process 200 continues at block 204 with blocking open holes of the inner container. As described below, the inner container is filled on its side; blocking the open holes prevents loss of solid phase gas source through the holes during fill.

FIG. 9B shows an example of the inner container 106 with a pole 142 inserted into the central tube 118. The pole 142 can prevent spillage, for example, by preventing solid phase gas source from entering the central tube 118 during fill. FIG. 10A shows another example of an inner container with open holes blocked. In the example of FIG. 10A, the inner container 106 includes holes 138 in the side of inner container, as well as holes 124 in central tube 118. As described above with reference to FIG. 6, the holes 138 allow gas flow between the inner container 106 and an outer channel. A side outer cover 148 is placed around a portion of the inner container 106 and covers holes 138 that are below a fill line when the inner container 106 is placed on its side.

Returning to FIG. 8, the process 200 continues at block 206 with opening a side of the inner container. This can allow side access to the separated volumes of the open container. In some implementations, a portion of the outer wall of the inner container is a side door movable to open a side of the inner container. The side door can be hinged or separable from the inner container, for example. FIG. 9C shows the inner container 102 with a side door 150 removed to allow access to separated volumes 122. As noted above the side door 150 can be hinged rather than separable from the inner container. In some implementations, the side door 150 can be sized such that opening the side door 150 establishes a fill line 152. As indicated above with respect to FIG. 3, at least about 50% of each separated volume 122 is filled with solid phase gas source. Accordingly, in some implementations, the side door 150 has a surface area of less than half the lateral surface area of the inner container 102.

FIG. 10B also shows an example of the inner container 106 shown in FIG. 10A with the side door 150 removed. In the example in FIG. 10B, the side door 150 includes holes 138. The outer side cover 148 blocks the holes 138 (not shown) in the remainder of the inner container 106, preventing spillage. A fill line 152 is also indicated in FIG. 10B.

Returning to FIG. 9, the process 200 continues at block 208 with partially filling the multiple separated volumes of the inner container with a solid phase gas source. Because the side door provides access to all of the separated volumes, the multiple volumes can be filled simultaneously with one filling process. In some implementations, block 208 involves pouring powdered solid phase gas source into the separated volumes of the inner container up to a fill line. As described above, the fill line can be demarcated by the opening left by the side door. Alternatively, a fill line can otherwise be indicated on the inside or outside of the inner container. FIGS. 9D and 9E show top and cross-sectional views, respectively, of the inner container 106 shown in FIGS. 9A-9C after fill. FIG. 10C shows a cross-sectional view of the inner container 106 shown in FIGS. 10A and 10B after fill.

The process 200 continues at block 210 with replacing the side door after fill. After block 210, the process 200 continues at block 212 with positioning the container upright. In some implementations, the inner container can be vibrated to facilitate settling. FIG. 9F shows replacement of the side door 150 prior to positioning the inner container 106 upright. FIGS. 9G and 9H show cross-sectional and isometric views, respectively, of the upright inner container 106 partially filled with solid phase gas source 114 and side door 150 closed. In some implementations, the inner container can be positioned inside an outer container after block 212. FIG. 9I shows an example of filled inner container 102 placed in an outer container 108. The central tube 118 remains inserted into the inner container, though it can also be removed prior to placement of the inner container 106 in the outer container 108.

After the inner container is positioned in a vertical or upright position, the process 200 continues at block 214 with the opening the holes of the inner container. Block 214 can involve removing a pole inserted in the inner container and/or removing an outer side cover in some implementations. Once the holes are opened, thereby allowing gas flow between the separated volumes of the inner container and one or more gas passageways, the inner container can be placed in the outer container, if not already done, and the flange positioned over the inner and outer containers to complete assembly of the canister.

FIGS. 9J and 10D show examples of assembled canisters. In FIG. 9J, the canister 102 includes the solid phase gas source 114 filled to a level below that of the holes 124 in the central tube 118. In FIG. 10D, the solid phase gas source 114 is filled to a level below that of both the holes 124 in the central tube 118 and the holes 138 in the outer walls of the inner container 106. The canister 102 is ready for connection to the reaction chamber, buffer tank, or other delivery source. A heating jacket can be placed around the canister 102 as described above.

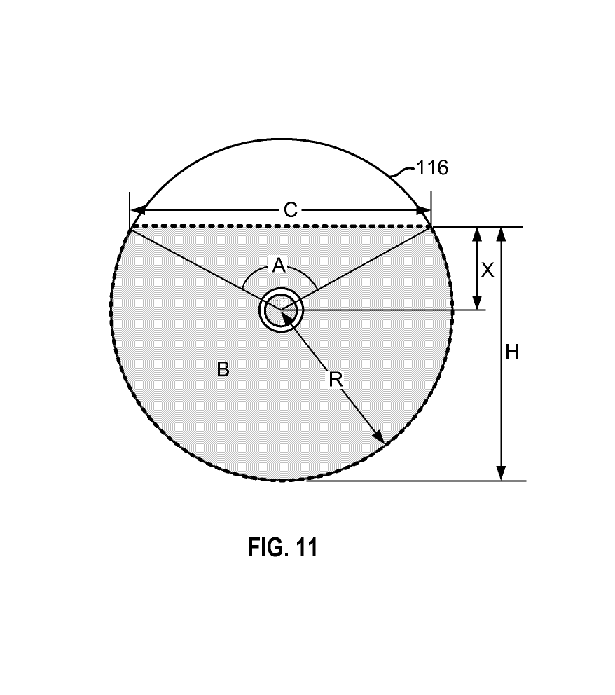

FIG. 11 shows an example of a schematic illustration of design dimensions of a shelf of a solid phase source gas canister. R is the radius of the canister, chord C of shelf 116 represents the fill line, X the distance of the chord from the center of the shelf, A the central angle of the chord C, and B the area of the shelf 116 below the fill line. For a given desired volume of fill, such as 80%, the shelf parameters can be calculated using the following Equation:

B=π−A/2+0.5 cos(A/2)sin(A/2)=0.8π (Equation 1)

X=R·cos(A/2) (Equation 2)

C=2R·sin(A/2) (Equation 3)

Table 1, below, provides an example of XeF₂ produced by four shelf canisters.

TABLE 1
Examples of XeF₂ production

| | | |
|---|---|---|
| shelf diameter (cm) | 30 | 20 |
| height of volume above each | 10 | 12 |
| shelf (cm) | | |
| total volume above each shelf, | 7,069 | 3,770 |
| including central tube and | | |
| heating rods (cm³) | | |
| volume above each shelf | 51 | 61 |
| occupied by central tube (cm³) | | |
| volume above each shelf | 10 | 10 |
| occupied by heating rods (% of | | |
| total) | | |
| fill percentage | 80% | 83% |
| total fill volume per shelf | 5,049 | 2,777 |
| XeF₂ packing density | 2.0 | 2.0 |
| (gram/cm³) | | |
| XeF₂ fill per shelf (gram) | 10,098 | 5,554 |

Various modifications to the implementations described in this disclosure may be readily apparent to those having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A solid phase source gas delivery system comprising:
a cylindrical inner container including a plurality of separated volumes configured to contain a plurality of separated quantities of a solid phase gas source, the volumes separated by shelves configured to support the quantities of the solid phase gas source;
a central tube extending through the inner container in fluid communication with the separated volumes; and
a side cover movable to access the separated volumes.

2. The solid phase source gas delivery system of claim 1, wherein the side cover is movable to access the separated volumes simultaneously.

3. The solid phase source gas delivery system of claim 1, wherein the side cover has a surface area of less than half the lateral surface area of the inner container.

4. The solid phase source gas delivery system of claim 1, further comprising an outer container configured to contain the inner container.

5. The solid phase source gas delivery system of claim 4, further comprising a gas passageway between the inner container and the outer container, wherein the gas passageway is in fluid communication with the separated volumes.

6. The solid phase source gas delivery system of claim 1, wherein the canister is configured such that sublimated vapor exits the canister through the central tube.

7. The solid phase source gas delivery system of claim 1, wherein the canister is configured for carrier gas injection through the central tube.

8. The solid phase source gas delivery system of claim 1, further comprising an outlet channel offset from the central tube, wherein the outlet channel diameter is greater than the central tube diameter.

9. The solid phase source gas delivery system of claim 1, wherein the canister produces XeF₂ vapor at a capacity of at least about 10 sccm per shelf.

10. The solid phase source gas delivery system of claim 1, further comprising a plurality of rods extending from each shelf into each separated volume.

11. The solid phase gas source delivery system of claim 1, wherein the delivery system is configured to deliver sublimated vapor to a substrate processing chamber.

12. A solid phase source gas delivery system comprising:
containing means for containing a plurality of separated quantities of a solid phase gas source; and
means for simultaneously introducing the separated quantities of the solid phase gas source to the delivery system.

13. The solid phase source gas delivery system of claim 12, further comprising means for providing a stream of sublimated vapor from the plurality of separated quantities of the solid phase gas source.

14. The solid phase source gas delivery system of claim 12, further comprising means for providing a carrier gas to the containing means.

15. The solid phase source gas delivery system of claim 12, further comprising means for preventing spillage while introducing the separated quantities to the delivery system.

16. A method of filling a solid phase source canister, comprising:
providing an inner container including a plurality of volumes separated by shelves;
blocking open holes of the inner container;
opening a side of the inner container;
partially filling the separated volumes with a solid phase gas source;
replacing the side cover;
positioning the inner container upright; and
opening the blocked holes of the inner container.

17. The method of claim 16, wherein the inner container further comprises a central tube extending through the inner container in fluid communication with the separated volumes.

18. The method of claim 16, wherein blocking open holes of the inner container includes inserting a pole into the central tube.

19. The method of claim 16, wherein the separated volumes are partially filled simultaneously.

20. The method of claim 16, further comprising vibrating the inner container to settle the solid phase gas source.

21. The method of claim 16, wherein the solid phase gas source is xenon difluoride (XeF₂).

22. The method of claim 16, further comprising heating the inner container to a temperature between about 30° C. and 60° C.
